(19) United States
(12) Patent Application Publication
(10) Pub. No.: US 2008/0233933 A1
(43) Pub. Date: Sep. 25, 2008

(54) Structured Conference Calls

(75) Inventors: Ezra Raphael Gilbert, Highland Park, NJ (US); Vipul Kishore Lalka, Highland Park, NJ (US); Venkat R. Gilakattula, Matawan, NJ (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/688,744

(22) Filed: Mar. 20, 2007

(51) Int. Cl. H04M 3/42

(52) U.S. Cl. 455/416

(57) ABSTRACT

A conference call is disclosed that is partitioned into two or more topics by a host. Participants to the conference call can then inform the illustrative embodiment which topic or topics they are interested in and where they can be reached over the course of the conference call. At that point, those people who are not interested in the immediate topic can hang up or put their terminal on mute or other go about their business. As the conference call progresses from topic to topic, the host, or another person, informs the illustrative embodiment which topic is next to be discussed. The illustrative embodiment then alerts the participants who indicated their interest in the topic if their terminal is on mute or standby and adds the participants that are not connected to the conference call at all.

### FIELD OF THE INVENTION

The present invention relates to telecommunications in general, and, more particularly, to new features of telecommunications systems.

### BACKGROUND OF THE INVENTION

Conference calls are a mainstay of modern business life, and, therefore, the need exists for inventions that improve conference calls.

### SUMMARY OF THE INVENTION

One of the principal disadvantages of conference calls in the prior art is that they often waste the participants' time. This is particularly true for participants who are only interested in one or more topics but who must listen for hours because they don't know when the topics of interest will be addressed. Furthermore, it is also true for participants whose input is needed for only a few minutes but who must listen for hours because they don't know when their input will be needed. The present invention enables conference calls that avoid some of these costs and disadvantages.

In accordance with the illustrative embodiments, a conference call is partitioned into two or more topics by the host. Participants to the conference call can then inform the illustrative embodiment which topic or topics they are interested in and where they can be reached over the course of the conference call. This can be accomplished via the telecommunications system or via a data interface. At that point, those people who are not interested in the immediate topic can hang up or put their terminal on mute or other go about their business. As the conference call progresses from topic to topic, the host, or another person, informs the illustrative embodiment which topic is next to be discussed. The illustrative embodiment then alerts the participants who indicated their interest in the topic if their terminal is on mute or standby and adds the participants that are not connected to the conference call at all. In this way the present invention prevents participants who are only interested in one or more topics from having to listen for hours for until those topics arise.

The present invention comprises establishing a call comprising a first telecommunications terminal, a second telecommunications terminal, and a third telecommunications terminal; receiving a first directive signal to transmit a first alert signal to the second telecommunications terminal when a first topic signal has been received; receiving the first topic signal; and transmitting the first alert signal to the second telecommunications signal because the first topic signal has been received.

### BRIEF DESCRIPTION OF THE DRAWINGS

FIG. 1 depicts a schematic diagram of the salient components of telecommunications system 100 in accordance with the first illustrative embodiment of the present invention.

FIG. 2 depicts a flowchart of the salient tasks performed by the first illustrative embodiment of the present invention.

FIG. 3 depicts a schematic diagram of the salient components of telecommunications system 300 in accordance with the second illustrative embodiment of the present invention.

FIG. 4 depicts a flowchart of the salient tasks performed by the second illustrative embodiment of the present invention.

### DETAILED DESCRIPTION

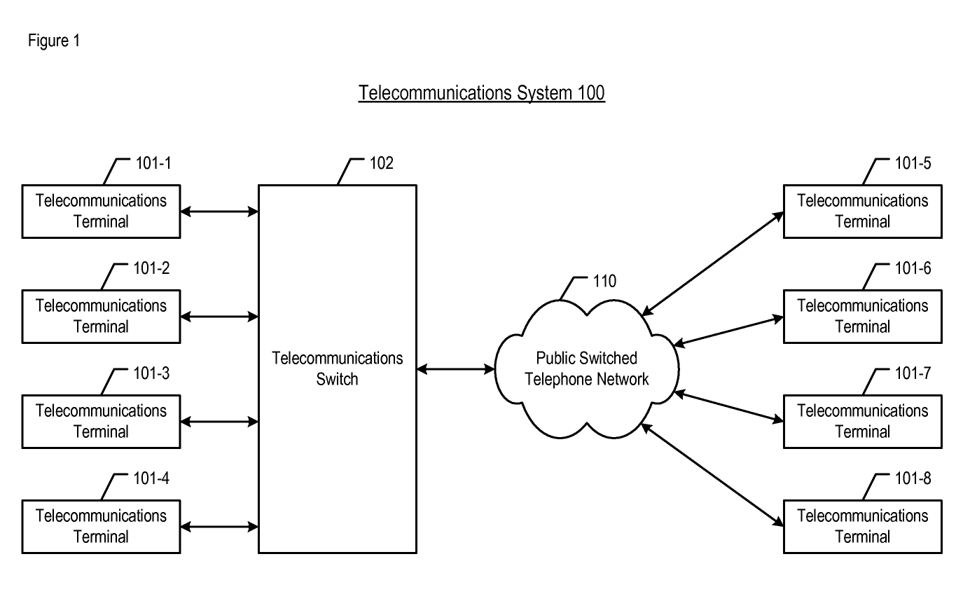

FIG. 1 depicts a schematic diagram of the salient components of telecommunications system 100 in accordance with the first illustrative embodiment of the present invention. Telecommunications system 100 comprises: telecommunications terminals 101-w, 101-x, 101-y, 101-z, 101-5, 101-6, 101-7, 101-8, telecommunications switch 102, and Public Switched Telephone Network (PSTN) 110, interconnected as shown.

The first illustrative embodiment is switch “centric” in the sense that all of the salient signaling to and from the various telecommunications terminals involves telecommunications switch 102. This is contrast to the second illustrative embodiment, which is described in detail below, in which the salient signaling between the telecommunications terminals is peer-to-peer and does not require a single centralized entity.

Although the first illustrative embodiment comprises four telecommunications terminals connected directly to telecommunications switch 102 and four telecommunications terminals connected to telecommunications switch 102 via Public Switched Telephone Network 110, it will be clear to those skilled in the art, after reading this specification, how to make and use alternative embodiments of the present invention that comprise:
i. any number of telecommunications terminals that are connected directly to telecommunications switch 102, or
ii. any number of telecommunications terminals that are connected to telecommunications switch 102 via Public Switched Telephone Network 110, or
iii. any combination of i and ii.

In accordance with the first illustrative embodiment, telecommunications terminal 101-i, wherein i ∈ {1, 2, 3, 4, 5, 6, 7, 8}, is a device (e.g. a cell-phone, wireless terminal, personal digital assistant, wireline telephone, etc.) that is capable of performing the functionality described below and in the accompanying figure. For example, telecommunications terminal 101-i provides bi-directional audio communications service to a user. Although the first illustrative embodiment comprises identical telecommunications terminals, it will be clear to those skilled in the art, after reading this specification, how to make and use embodiments of the present invention in which some or all of the telecommunications terminals are not identical. It will be clear to those skilled in the art, after reading this specification, how to make and use telecommunications terminal 101-i.

Telecommunications switch 102 is a switch that is capable of performing the functionality described below and the accompanying figures.

Public Switched Telephone Network 110 is the Public Switched Telephone Network as is well known to those skilled in the art. Although the first illustrative embodiment uses the Public Switched Telephone Network, it will be clear to those skilled in the art, after reading this specification, how to make and use alternative embodiments of the present invention that use a different network (e.g., the Internet, etc.).

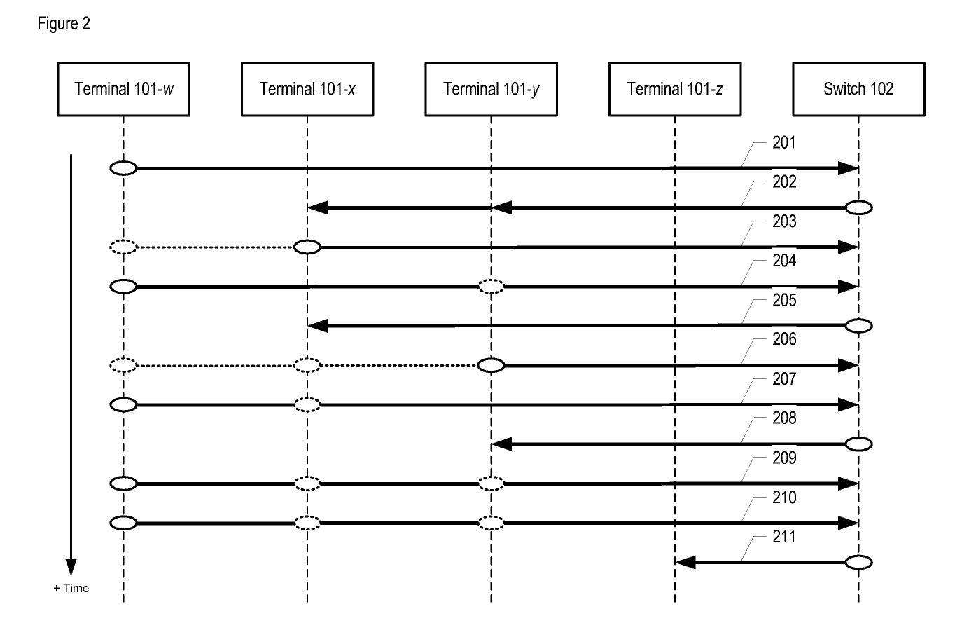

FIG. 2 depicts a flowchart of the salient tasks performed by the first illustrative embodiment of the present invention. The first illustrative embodiment comprises four telecommunications terminals 101-w, 101-x, 101-y, 101-z, and switch 102, wherein w, x, y, and z ∈ {1, 2, 3, 4, 5, 6, 7, 8} and w≠x≠y≠z.

At task 201, telecommunications terminal 101-w transmits and switch 102 receives a request to establish a call comprising telecommunications terminal 101-w, 101-x, and 101-y, in well-known fashion.

At task 202, switch 102 establishes a call comprising telecommunications terminal 101-w, 101-x, and 101-y, in well-known fashion.

At task 203, telecommunications terminal 101-x receives from its user a directive to alert the user of telecommunications terminal 101-x when a first topic signal is received by the first illustrative embodiment. As part of task 203, telecommunications terminal 101-x transmits and switch 102 receives a directive to transmit the first alert signal to telecommunications terminal 101-x when the first topic signal is received by switch 102.

It will be clear to those skilled in the art, after reading this specification, how to make and use alternative embodiments of the present invention in which it is telecommunications terminal 101-w, rather than telecommunications terminal 101-x, that receives from its user the directive to alert the user of telecommunications terminal 101-x when a first topic signal is received by the first illustrative embodiment. In these embodiments, it is telecommunications terminal 101-w, rather than telecommunications terminal 101-x, that transmits the directive to switch 102 that directs switch 102 to transmit an alert signal to telecommunications terminal 101-x when the first topic signal is received by switch 102.

At task 204, telecommunications terminal 101-w receives from its user the first topic signal. As part of task 204, telecommunications terminal 101-w transmits and switch 102 receives the first topic signal.

It will be clear to those skilled in the art, after reading this specification, how to make and use alternative embodiments of the present invention in which it is telecommunications terminal 101-y, rather than telecommunications terminal 101-w, that receives from its user the first topic signal. In these embodiments, it is telecommunications terminal 101-y, rather than telecommunications terminal 101-w, that transmits the first topic signal to switch 102.

At task 205, switch 102 transmits and telecommunications terminal 101-x receives the first alert signal because the first topic signal was received by switch 102. As part of task 205, telecommunications terminal 101-x informs its user to the receipt of the first topic signal.

At task 206, telecommunications terminal 101-y receives from its user a directive to alert the user of telecommunications terminal 101-y when a second topic signal is received by the first illustrative embodiment. As part of task 205, telecommunications terminal 101-y transmits and switch 102 receives a directive to transmit the second alert signal to telecommunications terminal 101-y when the second topic signal is received by switch 102.

It will be clear to those skilled in the art, after reading this specification, how to make and use alternative embodiments of the present invention in which it is either telecommunications terminal 101-w or 101-x, rather than telecommunications terminal 101-y, that receives from its use r the directive to alert the user of telecommunications terminal 101-y when the second topic signal is received by the first illustrative embodiment. In these embodiments, it is telecommunications terminal-w or 101-x, respectively, rather than telecommunications terminal 101-y, that transmits the directive to switch 102 that directs switch 102 to transmit an alert signal to telecommunications terminal 101-y when the second topic signal is received by switch 102.

At task 207, telecommunications terminal 101-w receives from its user the second topic signal. As part of task 204, telecommunications terminal 101-w transmits and switch 102 receives the second topic signal.

It will be clear to those skilled in the art, after reading this specification, how to make and use alternative embodiments of the present invention in which it is telecommunications terminal 101-x, rather than telecommunications terminal 101-w, that receives from its user the second topic signal. In these embodiments, it is telecommunications terminal 101-x, rather than telecommunications terminal 101-w, that transmits the second topic signal to switch 102.

At task 208, switch 102 transmits and telecommunications terminal 101-y receives the second alert signal because the second topic signal was received by switch 102. As part of task 205, telecommunications terminal 101-y informs its user to the receipt of the second topic signal.

At task 209, telecommunications terminal 101-w receives from its user a directive to add telecommunications terminal 101-z to the call when a third topic signal is received by the first illustrative embodiment. As part of task 209, telecommunications terminal 101-w transmits and switch 102 receives a directive to add telecommunications terminal 101-z to the call when the third topic signal is received by switch 102.

It will be clear to those skilled in the art, after reading this specification, how to make and use alternative embodiments of the present invention in which it is either telecommunications terminal 101-x or 101-y, rather than telecommunications terminal 101-w, that receives from its user the directive to add telecommunications terminal 101-z to the call when the third topic signal is received by the first illustrative embodiment. In these embodiments, it is telecommunications terminal-x or 101-y, respectively, rather than telecommunications terminal 101-w, that transmits the directive to switch 102 that directs switch 102 to add telecommunications terminal 101-z when the third topic signal is received by switch 102.

At task 210, telecommunications terminal 101-w receives from its user the third topic signal. As part of task 210, telecommunications terminal 101-w transmits and switch 102 receives the third topic signal.

It will be clear to those skilled in the art, after reading this specification, how to make and use alternative embodiments of the present invention in which it is either telecommunications terminal 101-x or 101-y, rather than telecommunications terminal 101-w, that receives from its user the third topic signal. In these embodiments, it is telecommunications terminal 101-x or 101-y, respectively, rather than telecommunications terminal 101-w, that transmits the third topic signal to switch 102.

At task 211, telecommunications switch 102 adds telecommunications terminal 101-z to the call comprising telecommunications terminal 101-w, 101-x, and 101-y, in well-known fashion.

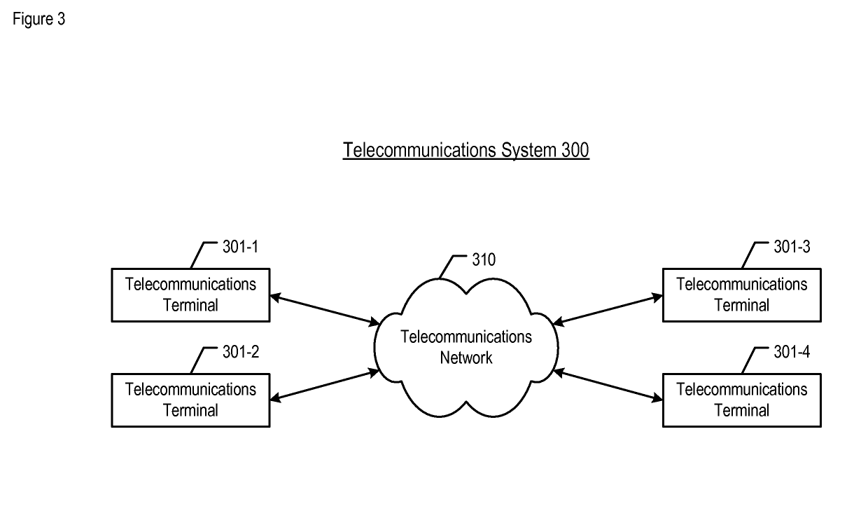

FIG. 3 depicts a schematic diagram of the salient components of telecommunications system 300 in accordance with the second illustrative embodiment of the present invention. Telecommunications system 300 comprises: telecommunications terminals 301-1, 301-2, 301-3, 301-4, and telecommunications network 310, interconnected as shown.

In accordance with the second illustrative embodiment, the salient signaling between the telecommunications terminals is peer-to-peer and does not involve a single centralized entity, in contrast to the signaling in the first illustrative embodiment, which is switch “centric” in the sense that all of the signaling to and from the various telecommunications terminals involves telecommunications switch 102.

Although the illustrative embodiment comprises four telecommunications terminals connected directly to telecommunications network 310, it will be clear to those skilled in the art, after reading this specification, how to make and use alternative embodiments of the present invention that comprise any number of telecommunications terminals.

In accordance with the second illustrative embodiment, telecommunications terminal 301-i, wherein i ∈ {1, 2, 3, 4}, is a device (e.g. a wireless, hands-free telephone headset, desk telephone, etc.) that is capable of performing the functionality described below and in the accompanying figure. For example, telecommunications terminal 301-i provides bi-directional audio communications service to one or more users. Although the second illustrative embodiment comprises identical telecommunications terminals, it will be clear to those skilled in the art, after reading this specification, how to make and use embodiments of the present invention in which some or all of the telecommunications terminals are identical. It will be clear to those skilled in the art, after reading this specification, how to make and use telecommunications terminal 301-i.

Telecommunications network 310 is the a TCP/IP network as is well known to those skilled in the art. Although the second illustrative embodiment uses TCP/IP, it will be clear to those skilled in the art, after reading this specification, how to make and use alternative embodiments of the present invention that use a different protocols.

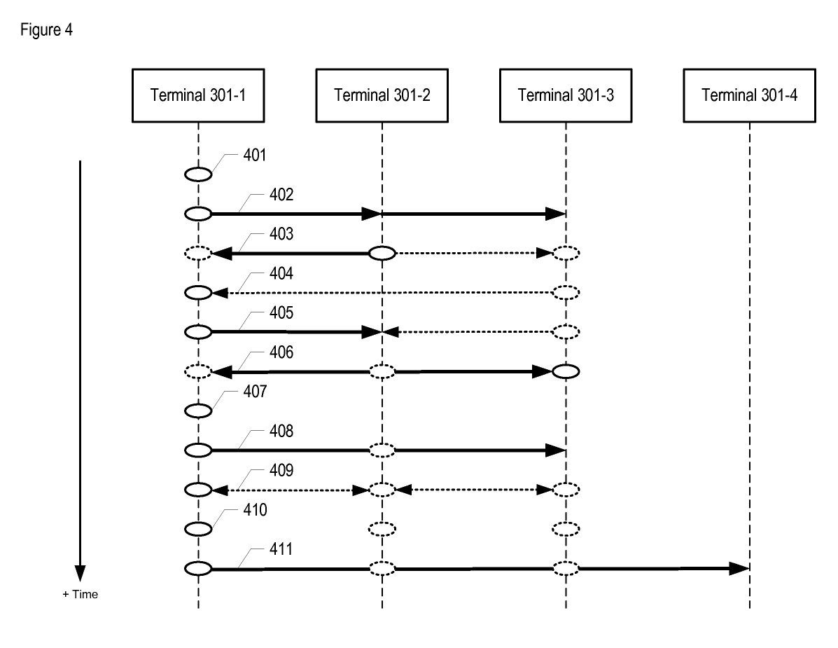

FIG. 4 depicts a flowchart of the salient tasks performed by the second illustrative embodiment of the present invention. In accordance with the second illustrative embodiment, all of the relevant signaling is between four telecommunications terminals 301-1, 301-2, 301-3, 301-4.

At task 401, telecommunications terminal 301-1 receives from its user a directive to establish a call comprising telecommunications terminal 301-1, 301-2, and 301-3, in well-known fashion. It will be clear to those skilled in the art, after reading this specification, how to make and use alternative embodiments of the present invention in which any combination of telecommunications terminal 301-1, 301-2, and 301-3 receives a directive to establish a call comprising telecommunications terminal 301-1, 301-2, and 301-3.

At task 402, telecommunications terminal 301-1 establishes a call comprising telecommunications terminal 301-1, 301-2, and 301-3, in well-known fashion. It will be clear to those skilled in the art, after reading this specification, how to make and use alternative embodiments of the present invention in which any combination of telecommunications terminal 301-1, 301-2, and 301-3 establish the call comprising telecommunications terminal 301-1, 301-2, and 301-3.

At task 403, telecommunications terminal 301-2 receives from its user a directive to alert the user of telecommunications terminal 301-2 when a first topic signal is received by telecommunications terminal 301-1. As part of task 403, telecommunications terminal 301-2 transmits and telecommunications terminal 301-1 receives a directive to transmit the first alert signal to telecommunications terminal 301-2 when the first topic signal is received by telecommunications terminal 301-1.

It will be clear to those skilled in the art, after reading this specification, how to make and use alternative embodiments of the present invention in which it is telecommunications terminal 301-1, rather than telecommunications terminal 301-2, that receives from its user the directive to alert the user of telecommunications terminal 301-2 when a first topic signal is received by telecommunications terminal 301-1. In these embodiments, either telecommunications terminal 301-1 waits for the first topic signal and sends the first alert itself, or telecommunications terminal 301-1 transmits a directive to telecommunications terminal 301-3, which waits for the first topic signal and sends the first alert itself.

Furthermore, it will be clear to those skilled in the art, after reading this specification, how to make and use alternative embodiments of the present invention in which it is telecommunications terminal 301-3, rather than telecommunications terminal 301-2, that receives from its user the directive to alert the user of telecommunications terminal 301-2 when a first topic signal is received by the second illustrative embodiment. In these embodiments, either telecommunications terminal 301-3 waits for the first topic signal and sends the first alert itself, or telecommunications terminal 301-3 transmits a directive to telecommunications terminal 301-1, which waits for the first topic signal and sends the first alert itself.

At task 404, telecommunications terminal 301-1 receives from its user the first topic signal. It will be clear to those skilled in the art, after reading this specification, how to make and use alternative embodiments of the present invention in which it is telecommunications terminal 301-3, rather than telecommunications terminal 301-1, that receives from its user the first topic signal.

Furthermore, it will be clear to those skilled in the art, after reading this specification, how to make and use alternative embodiments of the present invention in which telecommunications terminal 301-1 transmits the first topic signal to telecommunications terminal 301-3. And still furthermore, it will be clear to those skilled in the art, after reading this specification, how to make and use alternative embodiments of the present invention in which telecommunications terminal 301-3 transmits the first topic signal to telecommunications terminal 301-1.

At task 405, telecommunications terminal 301-1 transmits and telecommunications terminal 301-2 receives the first alert signal because the first topic signal was received by telecommunications terminal 301-1. As part of task 405, telecommunications terminal 301-2 informs its user to the receipt of the first topic signal.

It will be clear to those skilled in the art, after reading this specification, how to make and use alternative embodiments of the present invention in which telecommunications terminal 301-3 transmits and telecommunications terminal 301-2 receives the first alert signal.

At task 406, telecommunications terminal 301-3 receives from its user a directive to alert the user of telecommunications terminal 301-3 when a second topic signal is received by the second illustrative embodiment. As part of task 405, telecommunications terminal 301-3 transmits and telecommunications terminal 301-1 receives a directive to transmit the second alert signal to telecommunications terminal 301-3 when the second topic signal is received by telecommunications terminal 301-1.

It will be clear to those skilled in the art, after reading this specification, how to make and use alternative embodiments of the present invention in which it is telecommunications terminal 301-1, rather than telecommunications terminal 301-3, that receives from its user the directive to alert the user of telecommunications terminal 301-3 when the second topic signal is received by telecommunications terminal 301-1. In these embodiments, either telecommunications terminal 301-1 waits for the second topic signal and sends the first alert itself, or telecommunications terminal 301-1 transmits a directive to telecommunications terminal 301-2, which waits for the second topic signal and sends the first alert itself.

At task 407, telecommunications terminal 301-1 receives from its user the second topic signal. It will be clear to those skilled in the art, after reading this specification, how to make and use alternative embodiments of the present invention in which it is telecommunications terminal 301-2, rather than telecommunications terminal 301-1, that receives from its user the second topic signal.

At task 408, telecommunications terminal 301-1 transmits and telecommunications terminal 301-3 receives the second alert signal because the second topic signal was received by telecommunications terminal 301-1. As part of task 408, telecommunications terminal 301-3 informs its user to the receipt of the second topic signal.

It will be clear to those skilled in the art, after reading this specification, how to make and use alternative embodiments of the present invention in which it is telecommunications terminal 301-2, rather that telecommunications terminal 301-1, that transmits the second alert signal.

At task 409, telecommunications terminal 301-1 receives from its user a directive to add telecommunications terminal 301-4 to the call when a third topic signal is received by telecommunications terminal 301-1.

It will be clear to those skilled in the art, after reading this specification, how to make and use alternative embodiments of the present invention in which it is either telecommunications terminal 301-2 or 301-3, rather than telecommunications terminal 301-1, that receives from its user the directive to add telecommunications terminal 301-4 to the call when the third topic signal is received by the second illustrative embodiment.

Furthermore, it will be clear to those skilled in the art, after reading this specification, how to make and use alternative embodiments of the present invention in which the telecommunications terminal that receives the directive from its user transmits the directive to one of the other telecommunications terminals for monitoring.

At task 410, telecommunications terminal 301-1 receives from its user the third topic signal. It will be clear to those skilled in the art, after reading this specification, how to make and use alternative embodiments of the present invention in which it is either telecommunications terminal 301-2 or 301-3, rather than telecommunications terminal 301-1, that receives from its user the third topic signal.

At task 411, telecommunications terminal 301-1 adds telecommunications terminal 301-4 to the call comprising telecommunications terminal 301-1, 301-2, and 301-3, in well-known fashion. It will be clear to those skilled in the art, after reading this specification, how to make and use alternative embodiments of the present invention in which it is either telecommunications terminal 301-2 or 301-3, rather than telecommunications terminal 301-1, that adds telecommunications terminal 301-4 to the call. Furthermore, it will be clear to those skilled in the art, after reading this specification, how to make and use alternative embodiments of the present invention in which any of telecommunications terminal 301-1, 301-2, and 301-3 instructs one or more of the others to add telecommunications terminal 301-4 to the call.

It is to be understood that the disclosure teaches just two illustrative embodiments of the present invention and that many variations of the invention can easily be devised by those skilled in the art after reading this disclosure and that the scope of the present invention is to be determined by the following claims.

What is claimed is:

1. A method comprising:
establishing a call comprising a first telecommunications terminal, a second telecommunications terminal, and a third telecommunications terminal;
receiving a first directive signal to transmit a first alert signal to said second telecommunications terminal when a first topic signal has been received;
receiving said first topic signal; and
transmitting said first alert signal to said second telecommunications signal because said first topic signal has been received.

2. The method of claim 1 further comprising transmitting said first directive signal from said first telecommunications terminal.

3. The method of claim 1 further comprising transmitting said first directive signal from said second telecommunications terminal.

4. The method of claim 1 wherein said first directive signal is received at a telecommunications switch.

5. The method of claim 1 wherein said first directive signal is received at said first telecommunications terminal from a user of said first telecommunications terminal.

6. The method of claim 1 further comprising transmitting said first alert signal from a telecommunications switch.

7. The method of claim 1 further comprising transmitting said first alert signal from said first telecommunications terminal.

8. The method of claim 1 further comprising:
receiving a second directive signal to transmit a second alert signal to said second telecommunications terminal when a second topic signal has been received;
receiving said second topic signal; and
transmitting said second alert signal to said second telecommunications signal because said second topic signal has been received.

9. The method of claim 1 further comprising:
receiving a second directive signal to add a fourth telecommunications terminal to said call when a second topic signal has been received;
receiving said second topic signal; and
adding said fourth telecommunications signal to said conference call because said second topic signal has been received.

10. A method comprising:
establishing a call comprising a first telecommunications terminal and a second telecommunications terminal;
receiving a first directive signal to add a third telecommunications terminal to said call when a first topic signal has been received;
receiving said first topic signal; and
adding said third telecommunications terminal to said call because said first topic signal has been received.

11. The method of claim 10 further comprising transmitting said first directive signal from said first telecommunications terminal.

12. The method of claim 10 further comprising transmitting said first directive signal from said second telecommunications terminal.

13. The method of claim 10 wherein said first directive signal is received at a telecommunications switch.

14. The method of claim 10 wherein said first directive signal is received at said first telecommunications terminal from a user of said first telecommunications terminal.

15. The method of claim 10 wherein said third telecommunications terminal is added to said call by said first telecommunications terminal.

16. The method of claim 10 wherein said third telecommunications terminal is added to said call by said second telecommunications terminal.

17. The method of claim 10 further comprising:
receiving a second directive signal to transmit a first alert signal to said second telecommunications terminal when a second topic signal has been received;
receiving said second topic signal; and
transmitting said first alert signal to said second telecommunications signal because said second topic signal has been received.

18. The method of claim 10 further comprising:
receiving a second directive signal to add a fourth telecommunications terminal to said call when a second topic signal has been received;
receiving said second topic signal; and
adding said fourth telecommunications signal to said conference call because said second topic signal has been received.
